(19) United States
(12) Patent Application Publication
(10) Pub. No.: US 2002/0023164 A1
(43) Pub. Date: Feb. 21, 2002

(54) Method and apparatus for client-side authentication and stream selection in a content distribution system

(76) Inventor: Nils B. Lahr, Antioch Heights, CA (US)

Correspondence Address: Stacey J. Longanecker, Roylance, Abrams, Berdo & Goodman, L.L.P., Suite 600, 1300 19th Street, N.W., Washington, DC, 20036, US

(21) Appl. No.: 09/770,632

(22) Filed: Jan. 29, 2001

Related U.S. Application Data
(60) Provisional application No. 60/178,737, filed on Jan. 28, 2000.

(51) Int. Cl. G06F 15/16

(52) U.S. Cl. 709/231; 709/219

(57) ABSTRACT

A broadcast system for streaming media is provided. A tiered hierarchy of network components each receive broadcast media streams, store popular content, and serve media to clients. The system allows for real-time client-side authentication, stream selection, and stream access denial using data (e.g., metafile) provided between network components sharing a real-time streaming protocol communication.

This application claims the benefit of U.S. provisional application Ser. No. 60/178,737, filed Jan. 28, 2000.

### CROSS REFERENCE TO RELATED APPLICATIONS

Related subject matter is disclosed in co-pending U.S. patent application of Nils B. Lahr et al., filed Sep. 28, 1998, entitled “Streaming Media Transparency” (attorney's file IBC-P001); in co-pending U.S. patent application of Nils B. Lahr, filed even date herewith, entitled “Method and Apparatus for Encoder-Based Distribution of Live Video and Other Streaming Content” (attorney's file 39512A); in co-pending U.S. patent application of Nils B. Lahr, filed even date herewith, entitled “A System and Method for Rewriting a Media Resource Request and/or Response Between Origin Server and Client” (attorney's file 39511A); in co-pending U.S. patent application of Nils B. Lahr, filed even date herewith, entitled “Method And System For Real-Time Distributed Data Mining And Analysis for Networks” (attorney's file 39510A); in co-pending U.S. patent application of Nils B. Lahr, filed even date herewith, entitled “Method and Apparatus for Using Single Uniform Resource Locator for Resources With Multiple Formats” (attorney's file 39502A); in co-pending U.S. patent application of Nils B. Lahr et al., filed even date herewith, entitled “A System and Method for Mirroring and Caching Compressed Data in a Content Distribution System” (attorney's file 39565A); in co-pending U.S. patent application of Nils B. Lahr, filed even date herewith, entitled “A System and Method for Determining Optimal Server in a Distributed Network for Serving Content Streams” (attorney's file 39551A); and in co-pending U.S. patent application of Nils B. Lahr, filed even date herewith, entitled “A System and Method for Performing Broadcast-Enabled Disk Drive Replication in a Distributed Data Delivery System” (attorney's file 39564A); the entire contents of each of these applications being expressly incorporated herein by reference.

### BACKGROUND OF THE INVENTION

Internet service providers (ISPs) are not currently able to authenticate a client according to their current bandwidth, service availability, or capabilities. The term client as used herein is understood to be a computer system (e.g., workstation) that requests service of another computer system (e.g., server). With reference to FIG. 1, many clients or users 20 specify bandwidth information 23, among other properties, which is used by a remote server indicated generally at 25 such as a stream server to connect the client to the correct stream. Servers generally connect clients to the highest quality stream based on bandwidth information provided without authenticating clients according to their service subscription type.

Allowing the client to set the speed of the connection has a number of drawbacks. For example, a client can select the wrong bandwidth for their current connection speed or client subscription type such as when a 28 k modem user selects a 300 k multicast stream. This configuration results in poor quality reception for the user and increased difficult in managing a network for ISPs. Setting the connection speed using the client 10 does not account for the dynamic nature of connections such as when a user with a portable computer requests streams from either a home office with a 28 k modem connection or a commercial office with a T1 connection, or when users at a commercial office each attempt to access a stream that requires a substantial portion of the office T1 connection. Existing client-server technology also does not prevent a client from initiating a multicast stream whereby multiple streams flood an invalid connection (e.g., a connection based on a larger than valid connection speed provided to the server by the client).

A need therefore exists for a method of determining if a client stream request can be fulfilled before authorizing a connection to the requested stream. A need also exists for a method of allowing different client subscription types to be able to access different stream qualities, and for improved roaming (e.g., users requesting connections from different sites having different connection capabilities). In addition, a need exists for a method of allowing ISPs to transparently authenticate clients, as well as to manage network connections more effectively (e.g., to prevent multicast storms).

### SUMMARY OF THE INVENTION

The above-described drawbacks of existing client-server technology are overcome by a testing component provided between a client and a server in accordance with the present invention.

In accordance with one aspect of the present invention, the testing component overrides the programmed intelligence of a client to input bandwidth information for access to requested content and instead uses real-time information to authenticate the client and authorize a connection based on actual connection speed, client capability, among other factors.

In accordance with another aspect of the present invention, the testing component uses information regarding the client and service provider provided in the metafile corresponding to the request to determine if the client is authorized to have the access requested. Alternatively, the testing component can get information regarding the client and service provider via a Cookie, client IP address, local database, and so on.

In accordance with still yet another aspect of the present invention, the testing component can rewrite the client's request to the server or response from the server in order to deny a specific service to a client. Priority among the access requests can be based on business contracts between ISPs and content providers.

### BRIEF DESCRIPTION OF DRAWINGS

The various aspects, advantages and novel features of the present invention will be more readily comprehended from the following detailed description when read in conjunction with the appended drawings, in which:

FIG. 1 illustrates a conventional client-server connection;

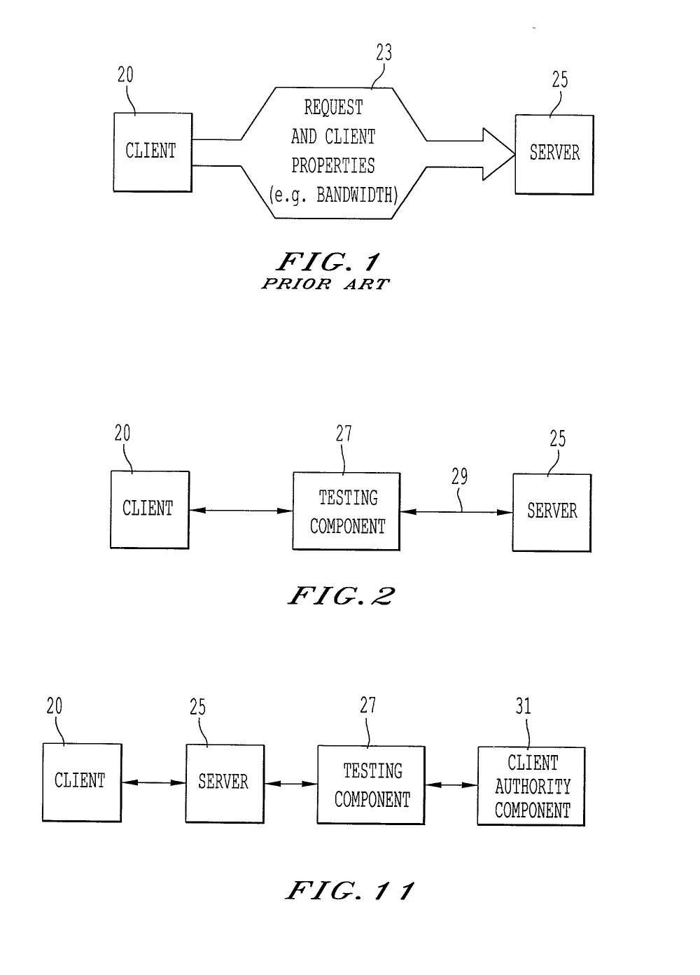

FIG. 2 illustrates a client-side testing, authentication and stream selection device constructed in accordance with an embodiment of the present invention;

FIG. 3 illustrates an Internet broadcast system for streaming media constructed in accordance with an embodiment of the present invention;

FIG. 4 is a block diagram of a media serving system constructed in accordance with an embodiment of the present invention;

FIG. 5 is a block diagram of a data center constructed in accordance with an embodiment of the present invention;

FIG. 6 illustrates data flow in a Internet broadcast system for streaming media constructed in accordance with an embodiment of the present invention;

FIGS. 7, 8 and 9 illustrate acquisition, broadcasting and reception phases employed in a Internet broadcast system for streaming media constructed in accordance with an embodiment of the present invention;

FIG. 10 illustrates transport data management in a Internet broadcast system for streaming media constructed in accordance with an embodiment of the present invention; and

FIG. 11 illustrates a testing, authentication and stream selection device constructed in accordance with an embodiment of the present invention;

Throughout the drawing figures, like reference numerals will be understood to refer to like parts and components.

### DETAILED DESCRIPTION OF THE PREFERRED EMBODIMENTS

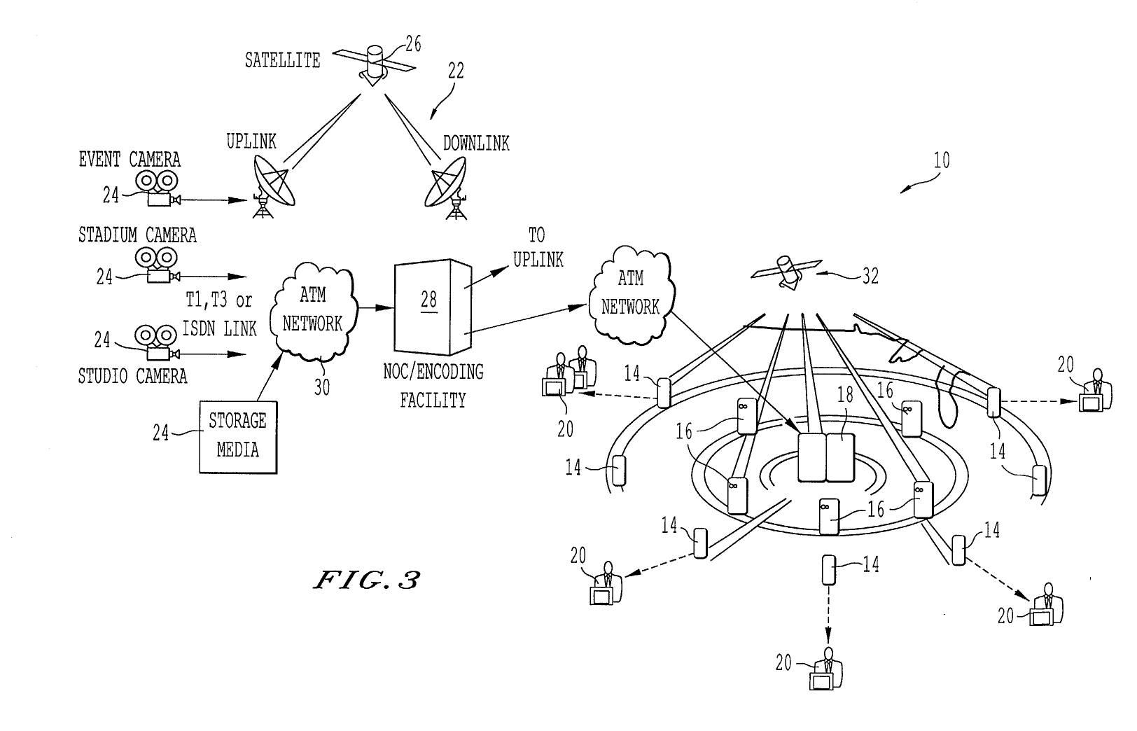

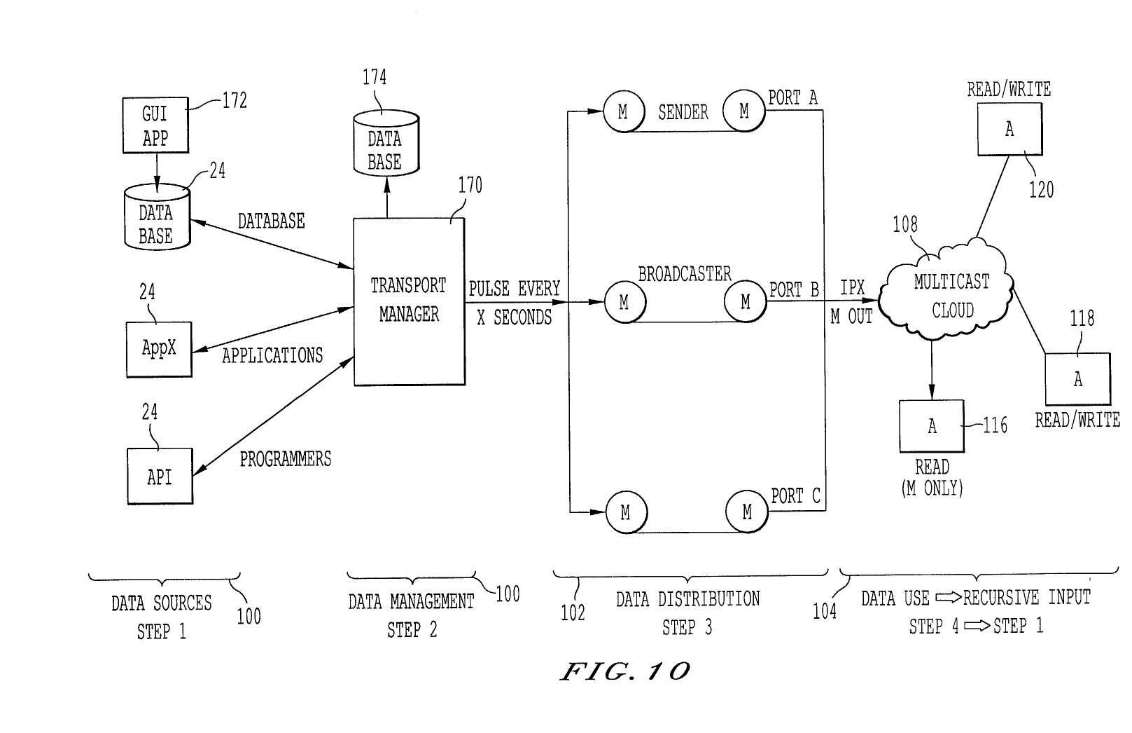

In accordance with the present invention, a testing component 27 is provided between a client 20 and a server 25, as shown in FIG. 2. The testing component 27 is operable to receive a request from the client 20 for access and to selectively establish a network connection 29 with the server 25 when the request has been authenticated, as described below. Another embodiment is described below in connection with FIG. 11 which allows a connection to go to a server that uses the testing component, as well as information from one or more client authorities, to validate tests, for example.

The testing component 27 can be implemented as an add-on software and/or hardware component provided that it can be configured to selectively establish or intercept (e.g., intercept events provided by a host application of which it is part) a network connection 29 between the client 20 and the server 25. The client-server relationship is described herein for illustrative purposes in connection with a content distribution system. An overview of an exemplary content distribution system 10 follows. The system 10 employs data transport protocols to implement the testing component 27 in accordance with the present invention. It is to be understood that implementation of the invention is not limited to the architecture of the illustrative system 10 described herein.

1. System Component Overview

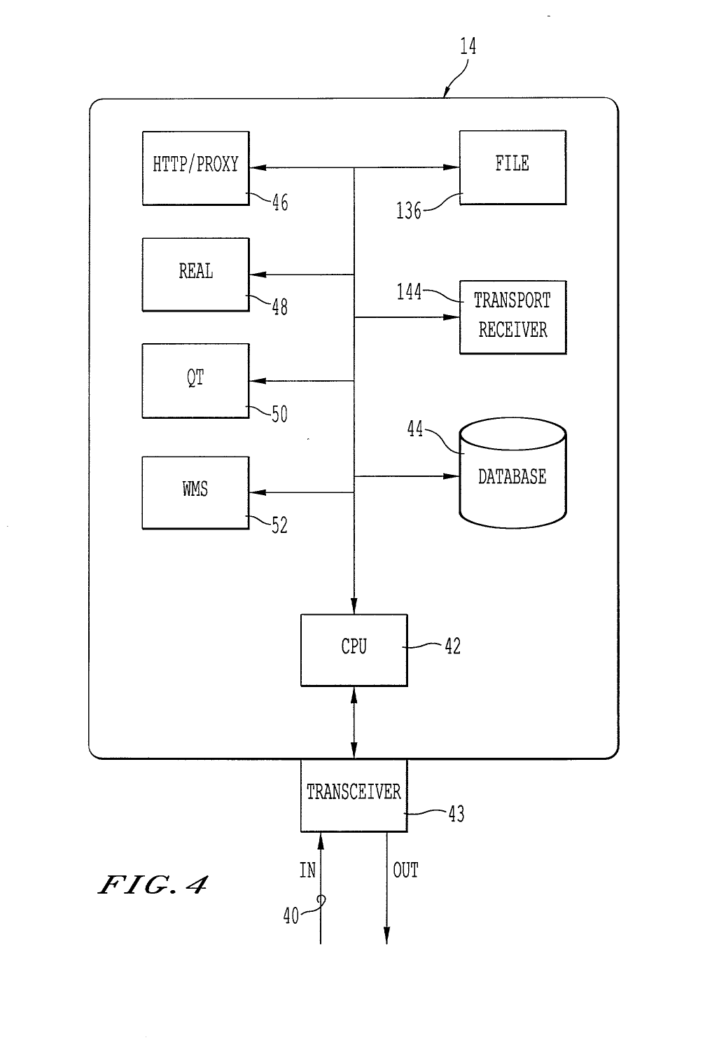

With reference to FIG. 3, a system 10 is provided which captures media (e.g., using a private network), and broadcasts the media (e.g., by satellite) to servers located at the edge of the Internet, that is, where users 20 connect to the Internet such as at a local Internet service provider or ISP. The system 10 bypasses the congestion and expense associated with the Internet backbone to deliver high-fidelity streams at low cost to servers located as close to end users 20 as possible.

To maximize performance, scalability and availability, the system 10 deploys the servers in a tiered hierarchy distribution network indicated generally at 12 that can be built from different numbers and combinations of network building components comprising media serving systems 14, regional data centers 16 and master data centers 18. The system also comprises an acquisition network 22 that is preferably a dedicated network for obtaining media or content for distribution from different sources. The acquisition network 22 can operate as a network operations center (NOC) which manages the content to be distributed, as well as the resources for distributing it. For example, content is preferably dynamically distributed across the system network 12 in response to changing traffic patterns in accordance with the present invention. While only one master data center 18 is illustrated, it is to be understood that the system can employ multiple master data centers, or none at all and simply use regional data centers 16 and media serving systems 14, or only media serving systems 14.

An illustrative acquisition network 22 comprises content sources 24 such as content received from audio and/or video equipment employed at a stadium for a live broadcast via satellite 26. The broadcast signal is provided to an encoding facility 28. Live or simulated live broadcasts can also be rendered via stadium or studio cameras, for example, and transmitted via a terrestrial network such as a T1, T3 or ISDN or other type of a dedicated network 30 that employs asynchronous transfer mode (ATM or other technology. In addition to live analog or digital signals, the content can include analog tape recordings, and digitally stored information (e.g., media-on-demand or MOD), among other types of content. Further, in addition to a dedicated link 30 or a satellite link 26, the content harvested by the acquisition network 22 can be received via the Internet, other wireless communication links besides a satellite link, or even via shipment of storage media containing the content, among other methods. The encoding facility 28 converts raw content such as digital video into Internet-ready data in different formats such as the Microsoft Windows Media (MWM), RealNetworks G2, or Apple QuickTime (QT) formats. The system 10 also employs unique encoding methods to maximize fidelity of the audio and video signals that are delivered via multicast by the distribution network 12.

With continued reference to FIG. 3, the encoding facility 28 provides encoded data to the hierarchical distribution network 12 via a broadcast backbone which is preferably a point-to-multipoint distribution network. While a satellite link indicated generally at 32 is used, the broadcast backbone employed by the system 10 of the present invention is preferably a hybrid fiber-satellite transmission system that also comprises a terrestrial network 33. The satellite link 32 is preferably dedicated and independent of a satellite link 26 employed for acquisition purposes. The tiered network building components 14, 16 and 18 are each equipped with satellite transceivers to allow the system 10 to simultaneously deliver live streams to all server tiers 14, 16 and 18 and rapidly update on-demand content stored at any tier. When a satellite link 32 is unavailable or impractical, however, the system 10 broadcasts live and on-demand content though fiber links provided in the hierarchical distribution network 12. Where the feed is pulled from in case of a failure is based on a set of routing rules that include priorities, weighting, and so on. In other words, the feed is pulled in a manner similar to the way routers currently operate, but at the actual stream level.

The system 10 employs a director agent to monitor the status of all of the tiers of the distribution network 12 and redirect users 20 to the optimal server, depending on the requested content. The director agent can originate, for example, from the NOC/encoding facility 28. The system employs an Internet Protocol or IP address map to determine where a user 20 is located and then identifies which of the tiered servers 14, 16 and 18 can deliver the highest quality stream, depending on network performance, content location, central processing unit load for each network component, application status, among other factors. Cookies and data from other databases can also be employed to facilitate this system intelligence.

Media serving systems 14 comprise hardware and software installed in ISP facilities at the edge of the Internet. The media serving systems preferably only serve users 20 in its subnetwork. Thus, the media serving systems 14 are configured to provide the best media transmission quality possible because the end users 20 are local. A media serving system 14 is similar to an ISP caching server, except that the content served from the media serving system is controlled by the content provider that input the content into the system 10. The media serving systems 14 each serve live streams delivered by the satellite link 32, and store popular content such as current and/or geographically-specific news clips. Each media serving system 14 manages its storage space and deletes content that is less frequently accessed by users 20 in its subnetwork. Content that is not stored at the media serving system 14 can be served from regional data centers.

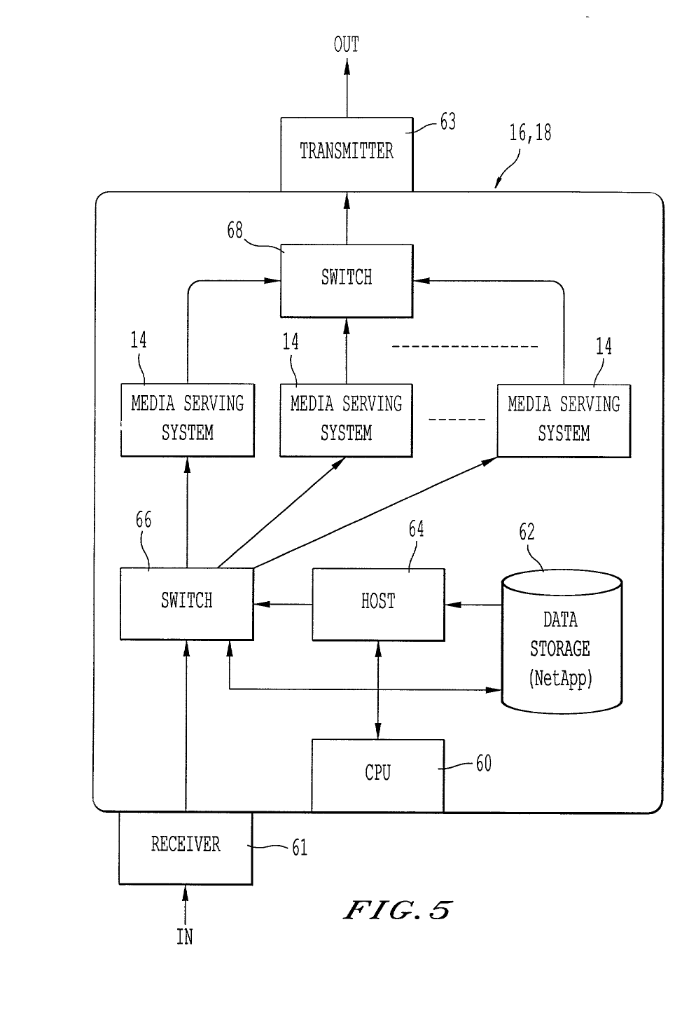

With reference to FIG. 4, a media serving system 14 comprises an input 40 from a satellite and/or terrestrial signal transceiver 43. The media serving system 14 can output content to users 20 in its subnetwork or control/feedback signals for transmission to the NOC or another hierarchical component in the system 10 via a wireline or wireless communication network. The media serving system 14 has a central processing unit 42 and a local storage device 44. A file transport module 136 and a transport receiver 144, which are described below with reference to FIG. 9, are provided to facilitate reception of content from the broadcast backbone. The media serving system 14 also preferably comprises one or more of an HTTP/Proxy server 46, a Real server 48, a QT server 50 and a WMS server 52 to provide content to users 20 in a selected format. The media serving system can also support Windows and Real caching servers, allowing direct connections to a local box regardless of whether the content is available. The content in the network 12 is then located and cached locally for playback. This allows for split live feeds by a local media serving system 14 regardless of whether is being sent via a broadcast or feed mechanism. Thus, pull splits from a media serving system 14 are supported, as well as broadcast streams that are essentially push splits with forward caching.

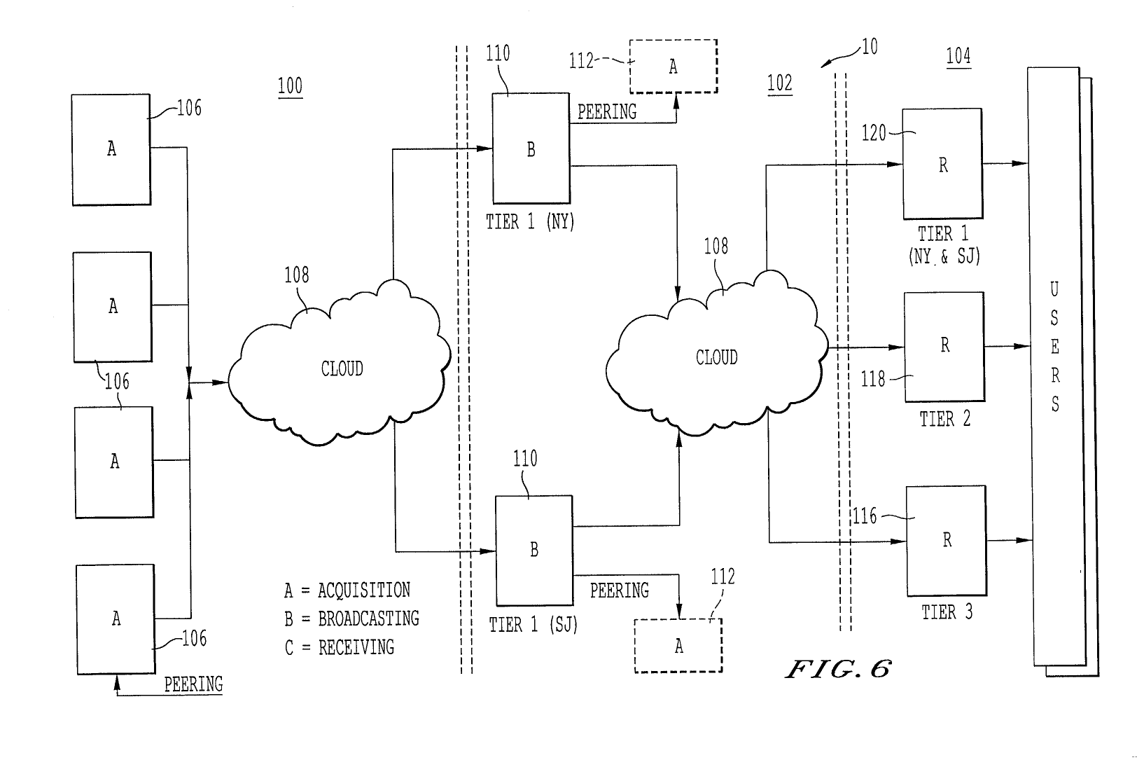

The regional data centers 16 are located at strategic points around the Internet backbone. With reference to FIG. 5, a regional data center 16 comprises a satellite and/or terrestrial signal transceiver, indicated at 61 and 63, to receive inputs and to output content to users 20 or control/feedback signals for transmission to the NOC or another hierarchical component in the system 10 via wireline or wireless communication network. A regional data center 16 preferably has more hardware than a media serving system 14 such as gigabit routers and load-balancing switches 66 and 68, along with high-capacity servers (e.g., plural media serving systems 14) and a storage device 62. The CPU 60 and host 64 are operable to facilitate storage and delivery of less frequently accessed on-demand content using the servers 14 and switches 66 and 68. The regional data centers 16 also deliver content if a standalone media serving system 14 is not available to a particular user 20. The director agent software preferably continuously monitors the status of the standalone media serving systems 14 and reroutes users 20 to the nearest regional data center 16 if the nearest media serving system 14 fails, reaches its fulfillment capacity or drops packets. Users 20 are typically assigned to the regional data center 14 that corresponds with the Internet backbone provider that serves their ISP, thereby maximizing performance of the second tier of the distribution network 12. The regional data centers 14 also serve any users 20 whose ISP does not have an edge server.

The master data centers 18 are similar to regional data centers 16, except that they are preferably much larger hardware deployments and are preferably located in a few peered data centers and co-location facilities, which provide the master data centers with connections to thousands of ISPs. With reference to FIG. 5, master data centers 18 comprises multiterabyte storage systems (e.g., a larger number of media serving systems 14) to manage large libraries of content created, for example, by major media companies. The director agent automatically routes traffic to the closest master data center 18 if a media serving system 14 or regional data center 16 is unavailable. The master data centers 18 can therefore absorb massive surges in demand without impacting the basic operation and reliability of the network.

Transmissions can occur out of the data centers 16 and 18. In the case of the satellite 32, however, transmissions can also be implemented by taking what is being received and routing a copy thereof directly to the uplink system without first passing through the media serving systems 14.

2. System Operation Overview

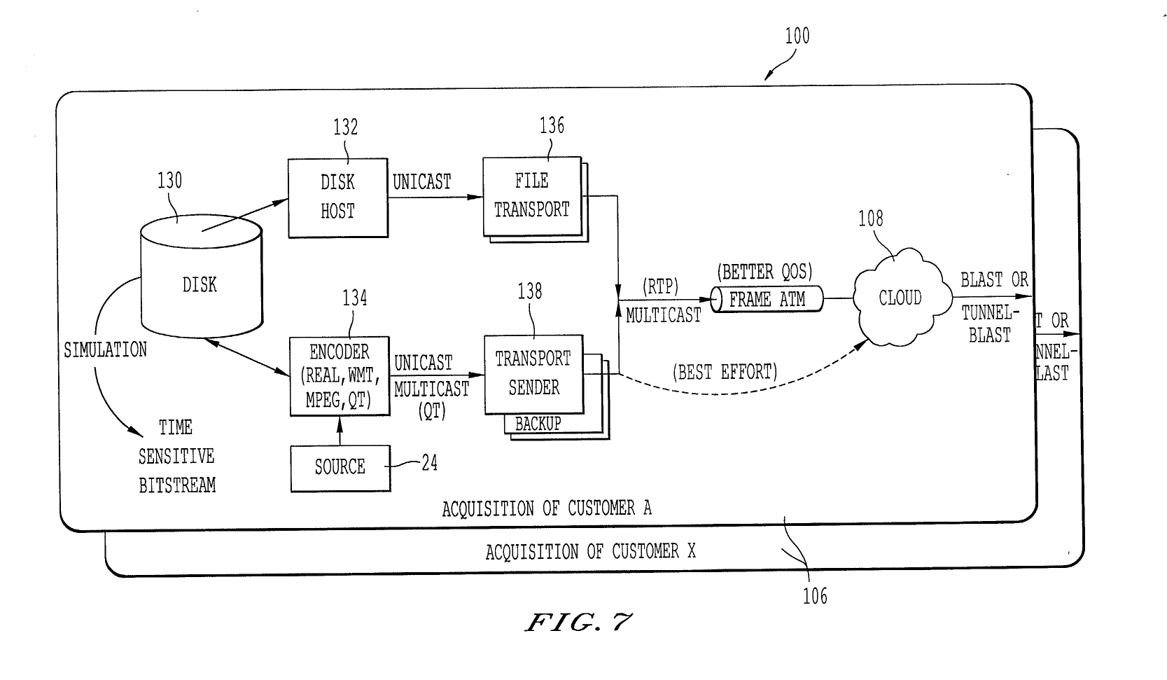

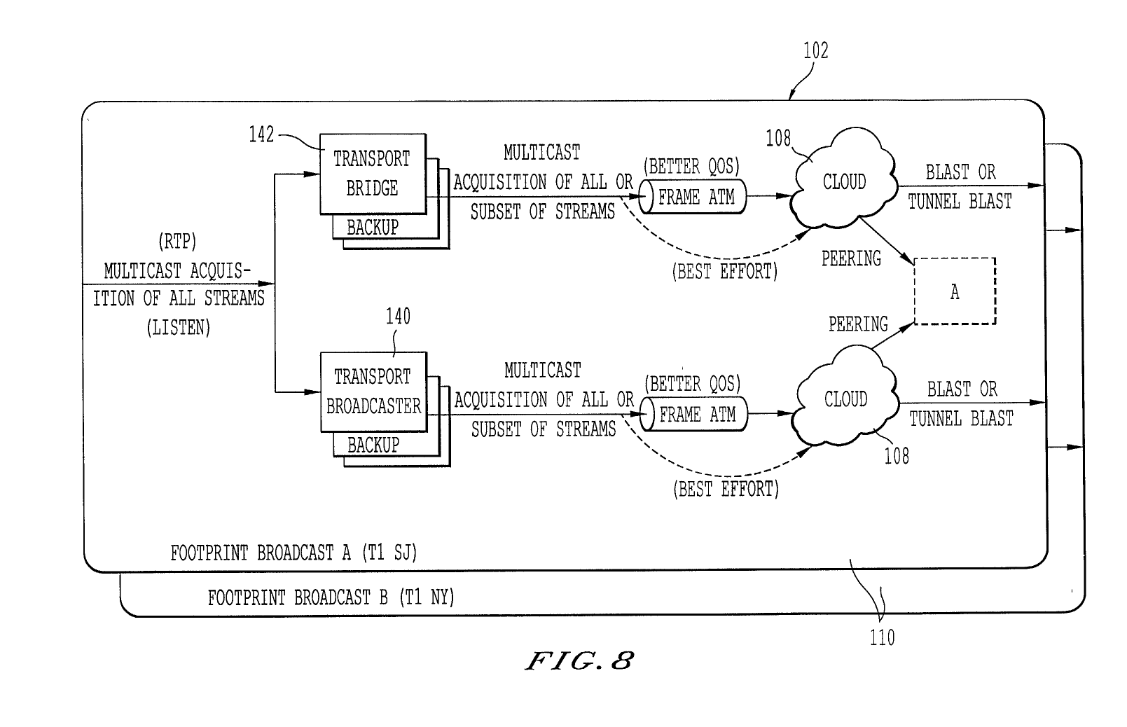

With reference to FIG. 6, the Internet broadcast system 10 for streaming media generally comprises three phases, that is, acquisition 100, broadcasting 102 and receiving 104. In the acquisition phase 100, content is provided to the system 10 from different sources such as Internet content providers (ICPs) or event or studio content sources. As stated previously, content can be received from audio and/or video equipment employed at a stadium for a live broadcast. The content can be, for example, live analog signals, live digital signals, analog tape recordings, digitally stored information (e.g., media-on-demand or MOD), among other types of content. The content can be locally encoded or transcoded at the source using, for example, file transport protocol (FTP), MSBD, or real-time transport protocol/real-time streaming protocol (RTP/RTSP). The content is collected using one or more acquisition modules 106, which are described in more detail below in connection with FIG. 7. The acquisition modules 106 represent different feeds to the system 10 in the acquisition network 12 and can be co-located or distributed. Generally, acquisition modules 106 can perform remote transcoding or encoding of content using FTP, MSBD, or RTP/RTSP or other protocols prior to transmission to a broadcaster 110 for multicast to edge devices and subsequent rendering to users 20 located relatively near to one of the edge devices. The content is then converted into a broadcast packet in accordance with an aspect of the present invention. This process of packaging packets in a manner to facilitate multicasting, and to provide insight at reception sites as to what the packets are and what media they represent, constitutes a significant advantage of the system 10 over other content delivery systems.

Content obtained via the acquisition phase 100 is preferably provided to one or more broadcasters 110 via a multicast cloud or network(s) 108. The content is unicast or preferably multicast from the different acquisition modules 106 to the broadcasters 110 via the cloud 108. As stated above, the cloud 108 is preferably a point-to-multipoint broadcast backbone. The cloud 108 can be implemented as one or more of a wireless network such as a satellite network or a terrestrial or wireline network such as optical fiber link. The cloud 108 can employ a dedicated ATM link or the Internet backbone, as well as a satellite link, to multicast streaming media. The broadcasters 110 are preferably in tier 120, that is, they are master data centers 18 that receive content from the acquisition modules 106 and, in turn, broadcast the content to other receivers in tiers 116, 118 and 120.

During the broadcasting phase 102, broadcasters 110 operate as gatekeepers, as described below in connection with FIG. 8, to transmit content to a number of receivers in the tiers 116, 118 and 120 via paths in the multicast cloud 108. The broadcasters 110 support peering with other acquisition modules indicated generally at 112. The peering relationship between a broadcaster 110 and an acquisition module 112 is via a direct link and each device agrees to forward the packets of the other device and to otherwise share content directly across this link, as opposed to a standard Internet backbone.

During the reception phase 104, high-fidelity streams that have been transmitted via the broadcasters 110 across the multicast cloud 108 are received by servers 14, 16 and 18 located as close to end users as possible. The system 10 is therefore advantageous in that streams bypass congestion and expense associated with the Internet backbone. As stated previously, the servers are preferably deployed in a tiered hierarchy comprising media serving systems 14, regional data centers 16 and master data centers 18 that correspond to tiers 116, 118 and 120, respectively. The tiers 116, 118 and 120 provide serving functions (e.g., transcoding from RTP to MMS, RealNet, HTTP, WAP or other protocol), as well as delivery via a local area network (LAN), the Internet, a wireless network or other network to user devices 122 for rendering (e.g., PCs, workstations, set-top boxes such as for cable, WebTV, DTV, and so on, telephony devices, and the like). The tiers in the reception phase are described in further detail below in connection with FIG. 9.

3. Data Transport Management

With reference to FIGS. 7, 8 and 9, hardware and/or software components associated with the acquisition 100, broadcasting 102 and reception phases 104 will now be described. These hardware and/or software components comprise various transport components for supporting MOD or live stream content distribution in one or more multicast-enabled networks in the system 10. The transport components can be, but are not limited to, a file transport module, a transport sender, a transport broadcaster, and a transport receiver. The content is preferably characterized as either live content and simulated/scheduled live content, or MOD (i.e., essentially any file). Streaming media such as live content or simulated/scheduled live content are managed and transported similarly, while MOD is handled differently.

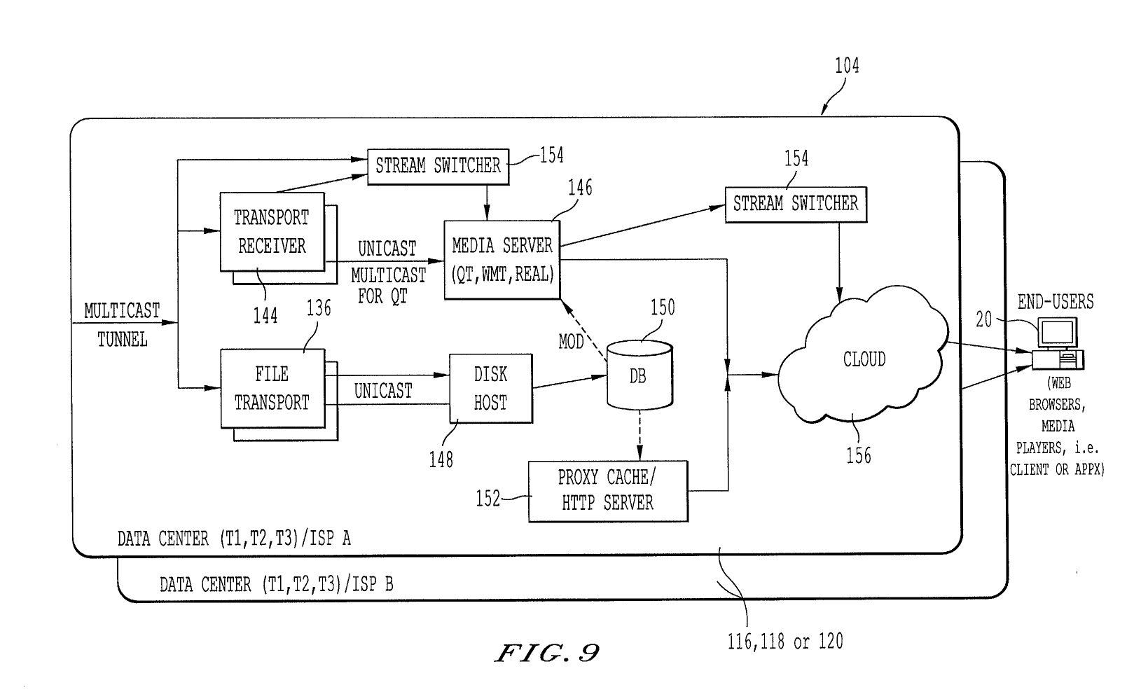

Acquisition for plural customers A through X is illustrated in FIG. 7. By way of an example, acquisition for customer A involves an encoder, as indicated at 134, which can employ Real, WMT, MPEG, QT, among other encoding schemes with content from a source 24. The encoder also encodes packets into a format to facilitate broadcasting in accordance with the present invention. A disk 130 stores content from different sources and provides MOD streams, for example, to a disk host 132. The disk host 132 can be proxying the content or hosting it. Live content, teleconferencing, stock and weather data generating systems, and the like, on the other hand, is also encoded. The disk host 132 unicasts the MOD streams to a file transport module 136, whereas the encoder 134 provides the live streams to a transport sender 138 via unicast or multicast. The encoder can employ either unicast or multicast if QT is used. Conversion from unicast to multicast is not always needed, but multicast-to-multicast conversion can be useful. The file transport module 136 transfers MOD content to a multicast-enabled network. The transport sender 138 pulls stream data from a media encoder 134 or an optional aggregator and sends stream announcements (e.g., using session announcement protocol and session description protocol (SAP/SDP)) and stream data to multicast Internet protocol (IP) addresses and ports received from a transport manager. The transport manager is described below with reference to FIG. 10. When a Real G2 server is used to push a stream, as opposed to a pulling scheme, an aggregator can be used to convert from a push scheme to a pull scheme. The components described in connection with FIG. 7 can be deployed at the encoding center 28 or in a distributed manner at, for example, content provider facilities.

FIG. 8 illustrates an exemplary footprint for one of a plurality of broadcasts. As shown in FIG. 8, the broadcasting phase 102 is implemented using a transport broadcaster 140 and a transport bridge 142. These two modules are preferably implemented as one software program, but different functions, at a master data center 18 or network operations center. The transport broadcaster 140 performs transport path management, whereas the transport bridge 142 provides for peering. The broadcaster 140 and bridge 142 get data from the multicast cloud (e.g., network 108) being guided by the transport manager and forward it to an appropriate transport path. One transport broadcaster 140, for example, can be used to represent one transport path such as satellite uplink or fiber between data centers or even a cross-continental link to a data center in Asia from a data center in North America. The broadcaster 140 and bridge 142 listen to stream announcements from transport senders 138 and enable and disable multicast traffic to another transport path, accordingly. They can also tunnel multicast traffic by using TCP to send stream information and data to another multicast-enabled network. Thus, broadcasters 110 transmit corresponding subsets of the acquisition phase streams that are sent via the multicast cloud 108. In other words, the broadcasters 110 operate as gatekeepers for their respective transport paths, that is, they pass any streams that need to be sent via their corresponding path and prevent passage of other streams. Transmission can also be accomplished using TCP to another receiver regardless whether the system that the receiver is in is multicast-enabled. Thus, multicast operation can be disabled and the broadcast is still routed and distributed, although not quite as effectively or inexpensively as multicast.

FIG. 9 illustrates the reception phase 104 at one of a plurality of servers or data centers. As stated above, the data centers are preferably deployed in a tiered hierarchy 116, 118 and 120 comprising media serving systems 14, regional data centers 16 and master data centers 18, respectively. The tiers 116, 118 and 120 each comprise a transport receiver 144. Transport receivers can be grouped using, for example, the transport manager. Each transport receiver 144 receives those streams from the broadcasters 110 that are being sent to a group to which the receiver belongs. The transport receiver listens to stream announcements, receives stream data from plural transport senders 138 and feeds the stream data to media servers 146. The transport receiver 144 can also switch streams, as indicated at 154 (e.g., to replace a live stream with a local MOD feed for advertisement insertion purposes). The stream switch 154 can be a plug-in in the Media Server 14 or exist in the server itself to enable switching per end-user 20. The plug-in can interact with an advertisement platform to inject advertisements into streams. The MOD streams are received via the file transport 136 and stored, as indicated via the disk host 148, database 150 and proxy cache/HTTP server 152. The servers 146 and 152 provide content streams to users 20.

The transport components described in connection with FIGS. 7, 8 and 9 are advantageous in that they generalize data input schemes from encoders and optional aggregators to data senders, data packets within the system 10, and data feeding from data receivers to media servers, to support essentially any media format. The transport components preferably employ RTP as a packet format and XML-based remote procedure calls (XBM) to communicate between transport components.

The transport manager will now be described with reference to FIG. 10 which illustrates an overview of transport data management. The transport manager is preferably a software module deployed at the encoding facility 28 or other facility designated as a NOC. As shown in FIG. 10, multiple data sources 14 (e.g., database content, programs and applications) provide content as input into the transport manager 170. Information regarding the content from these data sources is also provided to the transport manager such as identification of input source 14 and output destination (e.g., groups of receivers). Decisions as to where content streams are to be sent and which groups of servers are to receive the streams can be predefined and indicated to the transport manager 170 as a configuration file or XBM function call in real-time. This information can also be entered via a graphical user interface (GUI) 172 or command line utility. In any event, the information is stored in a local database 174. The database 174 also stores information for respective streams relating to defined maximum and minimum IP address and port ranges, bandwidth usage, groups or communities intended to receive the streams, network and stream names, as well as information for user authentication to protect against unauthorized use of streams or other distributed data.

With continued reference to FIG. 10, a customer requests to stream content via the system 10 using, for example, the GUI 172. The request can include the customer's name and account information, the stream name to be published (i.e., distributed) and the IP address and port of the encoder or media server from which the stream can be pulled. Requests and responses are sent via the multicast network (e.g., cloud 108) using separate multicast addresses for each kind of transport component (e.g., a transport sender channel, a broadcaster channel, a transport manager channel and a transport receiver channel), or one multicast address and different ports. IP and port combinations can be used for TCP transmissions. An operator at the NOC 28 can approve the request if sufficient system resources are available such as bandwidth or media server capacity. Automatic approval can be provided by a scheduling system configured to provide immediate responses to attempted broadcasts. The transport manager 170 preferably pulls stream requests periodically. In response to an approved request, the transport manager 170 generates a transport command in response to the request (e.g., an XML-based remote procedure call (XBM) to the transport sender 138 corresponding to that customer which provides the assigned multicast IP address and port that the transport sender is allowed to use in the system 10.

The transport sender 138 receives the XBM call and responds by announcing the stream that is going to be sent. All of the transport components listen to the announcement. Once the transport sender 138 commences sending the stream into the assigned multicast IP address and port, the corresponding transport broadcaster 140 filter the stream. The transport receiver 144 joins the multicast IP address and receives the data or stream if the stream is intended for a group to which the receiver 144 belongs. As stated above in connection with FIG. 6, the receiver converts the steam received via the cloud 108 and sends it to the media server available to the users 20. The data is then provided to the media server associated with the receiver. Receivers 144 and broadcasters 140 track announcements that they have honored using link lists.

As stated above, the transport components described with reference to FIGS. 6-10 preferably use RPT as a data transport protocol. Accordingly, Windows Media, RealG2 and QT packets are wrapped into RTP packets. The acquisition network 22 preferably employs an RTP stack to facilitate processing any data packets, wrapping the data packets with RTP header and sending the data packets. RTSP connection information is generally all that is needed to commence streaming.

RTP is used for transmitting real-time data such as audio and video, and particularly for time-sensitive data such as streaming media, whether transmission is unicast or multicast. RTP employs User Datagram Protocol (UDP), as opposed to Transmission Control Protocol (TCP) that is typically used for non-real-time data such as file transfer and e-mail. Unlike with TCP, software and hardware devices that create and carry UDP packets do not fragment and reassemble them before they have reached their intended destination, which is important in streaming applications. RTP adds header information that is separate from the payload (e.g., content to be distributed) that can be used by the receiver. The header information is merely interpreted as payload by routers that are not configured to use it.

RTSP is an application-level protocol for control over the delivery of data with real-time properties and provides an extensible framework to enable controlled, on-demand delivery of real-time data including live feeds and stored clips. RTSP can control multiple data delivery sessions, provide means for choosing delivery channels such as UDP, multicast UDP and TCP, and provide means for choosing delivery mechanisms based on RTP. HTTP is not suitable for streaming media because it is more of a store-and-forward protocol that is more suitable for web pages and other content that is read repeatedly. Unlike HTTP, RTSP is highly dynamic and provides persistent interactivity between the user device (hereinafter referred to as a client) and server that is beneficial for time-based media. Further, HTTP does not allow for multiple sessions between a client and server, and travels over only a single port. RTP can encapsulate HTTP data, and can be used to dynamically open multiple RTP sessions to deliver many different streams at the same time.

The system 10 employs transmission control software deployed at the encoding facilities 28, which can operate as a network operations center (NOC), and at broadcasters 110 (e.g., master data centers 120) to determine which streams will be available to which nodes in the distribution system 12 and to enable the distribution system 12 to support one-to-one streaming or one-to-many streaming. The extensible language capabilities of RTSP augment the transmission control software at the edge of the distribution network 12. Since RTSP is a bi-directional protocol, its use enables encoders 134 and receivers 144 to talk to each other, allowing for routing, conditional access (e.g., authentication) and bandwidth control in the distribution network 12. Standard RTSP proxies can be provided between any network components to allow them to communicate with each other. The proxy can therefore manage the RTSP traffic without necessarily understanding the actual content.

For every RTSP stream, there is an RTP stream. Further, RTP sessions support data packing with timestamps and sequence numbers. They can also be used for carrying stereo information, wide screen versions of requested media, different audio tracks, and so on. RTP packets are wrapped in a broadcast protocol. Applications in the receiving phase 104 can use this information to determine when to expect the next packet. Further, system operators can use this information to monitor network 12 and satellite 32 connections to determine the extent of latency, if any.

Encoders and data encapsulators written with RTP as the payload standard are advantageous because off-the-shelf encoders (e.g., MPEG2 encoders) can be introduced without changing the system 10. Further, encoders that output RTP/RTSP can connect to RTP/RTSP transmission servers. In addition, the use of specific encoder and receiver combinations can be eliminated when all of the media players support RTP/RTSP.

4. Testing Component

As stated above, transport management facilitates requests for streaming content by system customers (e.g., content providers). The use of RTP/RTSP between transport components also facilitates communication between servers and users requesting to receive content from the servers.

Media resource requests from a client 22 can occur inside of an RTSP connection or via a simple HTTP request. Responses to media resource requests can be metafiles, but can also occur inside of a binary file or via the protocol being used between the client 22 and server (e.g., server 14, 16 or 18). In each of these instances, responses are similar to a response served by an Internet client-server application to allow sending links to a resource rather than having to send the resource itself. These files and/or response information indicate to the client 22 the location of requested media, i.e., where it should connect to and in what order. In video serving applications, metafiles allow content providers to create playlists of video clips, but metafiles can also be used to help define events and other information such as the author or resource owner. Further, the contents of the metafiles can be written as more of a scriptable language to handle conditions and other more dynamic needs. In other words, RTSP can enable encoders 134, receivers 144, and servers or data centers 14, 16 and 18 to communicate with each other to allow for routing, conditional access (e.g., authentication) and bandwidth control in the distribution network 12, in accordance with the present invention. For example, standard RTSP proxies can be provided between any network components to allow them to communicate with each other.

With reference to the illustrative Internet broadcast system 10 for streaming media, the testing component 27 is implemented as a combination of software modules and hardware components in the system 10 and is operable to review properties of the client 20 in real-time using RTP/RTSP communications to determine, for example, the bandwidth and capability of the client. Information relating to these properties can be provided in a metafile corresponding to the request. The metafile can also provide information relating to the ISP such as client subscription type and priority to be provided the requested stream based on contracts between companies using the ISP and content providers. For example, a content provider can pay an ISP for higher quality of service. The testing component 27 is configurable to analyze requests and place higher priority to the content provider's connections than other requested traffic. The information for authenticating client requests can come from other sources via the Internet than the metafile associated with the request, such as from an ISP or other database.

The testing component 27 is operable to rewrite the metafile to deny service to clients that request higher bandwidth content than the priority or low-bandwidth connection for which they have paid. Since metafile qualities can be supported in an RTSP channel, the testing component can use a metafile as one type of response, or employ an RTSP comment, if supported, to deny, redirect, and so on, for a response. The testing component 27 is therefore useful to prevent relatively low-speed modems from requesting multicast feeds, for example, and thereby flooding the network. Service providers can also use the testing component 27 to restrict available streams according to client subscription type. A proxy for video requests is one way to make this transparent. Routers and switches in the system 10 can allow an application to reside between a client 22 and serve in a manner to allow the testing component 27 of the present invention to review client-server communications and make changes as needed.

The testing component can be implemented as part of the server and communicate with local components inside of an ISP to determine specific information pertaining to the client. This information can then be used to authenticate, among other functions. By way of an example, the media serving system 14 can be located inside of an ISP location. The media serving system 14 can be configured to point to a switch (e.g., a RedBack Switch), which contains information about customer accounts, customer addresses, bandwidth allowed, and so on. The media serving system 14 then contacts the RedBack Switch and uses the local account information as input to making its authentication decision. In addition, the media serving system 14 can be provided with Real, QT, and WMS components that also allow caching of data by using their Proxy editions. Also, the database 44 and file system 136 can be local or remote, depending on where the media serving system 14 is installed.

With reference to FIG. 11, and in accordance with another embodiment of the present invention, a client 20 can contacts a server 25, which then requests information from a testing component 27 that allows the server to makes an authentication decision. In other words, the testing component 27 is, or is used in conjunction with, a client authority component 31 that provides the testing component with authorized information about the client (e.g., the RedBack switch mentioned above) to allow the use of the data separately from where it is gathered. Thus, a connection goes to a server 25 that is also the testing component 27, but it gathers information from the client authority component(s) 31 in order to validate its tests.

The testing component 27 of the present invention is distinguishable from a subscriber devices management network (e.g., a network appliance connected to a cable modem or digital subscriber line). A subscriber devices management network manages a client and does not manage connections based on such information as bit rate, bandwidth and ISP information such as subscription type. Such a network also does not perform quality of service (QOS) or deny network connection availability. The testing component 27 of the present invention, on the other hand, provides a new layer of network management that is based on a stream, a contractual relationship with a content provider or other company, among other factors.

The authentication and selective network connection provided by the present invention allows networks to offer multi-tiered service (e.g., different users can access different types of streams), and control over user errors when requesting access (e.g., requesting incorrect bandwidth for their connection speed). Thus, service providers can distinguish users who have paid for value-added services and authenticate these users for higher quality digital audio and video services.

Although the present invention has been described with reference to a preferred embodiment thereof, it will be understood that the invention is not limited to the details thereof. Various modifications and substitutions will occur to those of ordinary skill in the art. All such substitutions are intended to be embraced within the scope of the invention as defined in the appended claims.

What is claimed is:

1. A method for processing media requests from clients in a content distribution system comprising the steps of:
preparing media for delivery via said content distribution system and storing delivery information relating to said media comprising at least one of bit rate, bandwidth and media subscription type;
analyzing request information transmitted from a client via a request for media, said request information comprising bandwidth and connection capability of said client; and
determining from said request information and said delivery information and substantially in real-time if said client can receive the requested said media within selected system constraints.

2. A method as claimed in claim 1, further comprising the step of denying said request if said client cannot receive the requested media within said selected system constraints.

3. A method as claimed in claim 2, further comprising the step of responding to a request via at least one of rewriting original metadata associated with said request, using protocol supported responses, and automatically generating metadata associated with said request to perform at least one of denying said client access to the requested media and redirecting said client.

4. A method as claimed in claim 1, wherein said request and a response to said request occur within a real-time streaming protocol connection.

5. A method for processing media requests from clients in a content distribution system comprising the steps of:
preparing media for delivery via said content distribution system and storing delivery information relating to which clients can access which media;
analyzing request information transmitted from a client via a request for media, said request information comprising client identification; and
determining from said delivery information and said request information and substantially in real-time if said client is authorized to receive the requested media.

6. A method as claimed in claim 5, further comprising the step of denying said request if said client is not authorized.

7. A method as claimed in claim 6, further comprising the step of responding to a request via at least one of rewriting original metadata associated with said request, using protocol supported responses, and automatically generating metadata associated with said request to perform at least one of denying said client access to the requested media and redirecting said client.

8. A method as claimed in claim 5, wherein said request and a response to said request occur within a real-time streaming protocol connection.

9. A method for processing media requests from clients in a content distribution system comprising the steps of:
preparing media for delivery via said content distribution system and storing delivery information relating to subscriptions to different types of said media;
analyzing request information transmitted from a client via a request for media, said request information comprising client identification; and
determining from said delivery information and said request information and substantially in real-time if said client is authorized to receive the requested media.

10. A method as claimed in claim 9, further comprising the step of prioritizing fulfillment of said request with respect to other requests depending on the type of said subscription associated with at least one of the requested media and said client.

11. A method as claimed in claim 9, further comprising the step of rewriting metadata associated with said request to deny said client access to the requested media.

12. A method as claimed in claim 9, wherein said request and a response to said request occur within a real-time streaming protocol connection.

13. A content distribution system comprising:
a plurality of servers from which to obtain streaming media;
an operations center for dynamically determining which of said servers are to serve which of a plurality of media streams and for redirecting clients to other said servers when the corresponding one of said servers does not store a requested media stream; and
a transport module operable to analyze communications between a client and one of said servers, which comprise a request for one of said media streams and a response, substantially in real-time to determine if said client can receive said media stream within selected system constraints.

14. A content distribution system as claimed in claim 13, wherein said communications occur within a real-time streaming protocol connection.

15. A content distribution system as claimed in claim 13, wherein said request is associated with metadata relating to at least one of client identification, and client bandwidth and connection capacity, said transport module being operable to deny client access to the requested media stream if said client cannot receive the requested media stream within selected system constraints.
